(19) United States
(12) Patent Application Publication
(10) Pub. No.: US 2023/0312904 A1
(43) Pub. Date: Oct. 5, 2023

(54) PHOTOCURABLE RESIN COMPOSITION, CURED FILM, AND MOLDED ARTICLE WITH CURED FILM

(71) Applicant: CHUGOKU MARINE PAINTS, LTD., Otake-shi, Hiroshima-ken (JP)

(72) Inventors: Kenji MIYAKUBO, Yasu-shi, Shiga-ken (JP); Yumiko ATSUJI, Yasu-shi, Shiga-ken (JP); Yoshinori KAMEDA, Yasu-shi, Shiga-ken (JP)

(73) Assignee: CHUGOKU MARINE PAINTS, LTD., Otake-shi, Hiroshima-ken (JP)

(21) Appl. No.: 18/018,358

(22) PCT Filed: Jul. 29, 2021
(86) PCT No.: PCT/JP2021/028082

§ 371 Date: Jan. 27, 2023

(30) Foreign Application Priority Data
Jul. 30, 2020 (JP) 2020-129632

(51) Int. Cl. C08L 33/10; C08F 20/18; C08K 5/07; C08K 5/5397; C08J 7/04; C08J 7/18; C08K 3/014

(52) U.S. Cl. CPC C08L 33/10; C08F 20/18; C08J 7/0427; C08J 7/18; C08K 3/014; C08K 5/07; C08K 5/5397; C08J 2333/10; C08K 2201/014; C08L 2203/16

(57) ABSTRACT

An object of the present invention is to provide a photocurable resin composition capable of forming a cured film having an excellent smoothness, adhesion, transparency, abrasion resistance, scratch resistance, crack resistance and weather resistance. [Solution to problem] The photocurable resin composition according to the present invention is a photocurable resin composition including a urethane (meth)acrylate (A), a (meth)acrylate monomer (B), a photopolymerization initiator (C) and a leveling agent (D); wherein the (meth)acrylate monomer (B) includes at least a bifunctional (meth)acrylate monomer (b1) and a hexafunctional (meth)acrylate monomer (b2); wherein the content of the urethane (meth)acrylate (A) is 45% by mass or more and 75% by mass or less with respect to the solid content of the photocurable resin composition; wherein the content of the (meth)acrylate monomer (B) is 20% by mass or more and 45% by mass or less with respect to the solid content of the photocurable resin composition; and wherein the content of the bifunctional (meth)acrylate monomer (b1) is 35°10 by mass or more with respect to the content of the (meth)acrylate monomer (B).

### BACKGROUND OF THE INVENTION

### Field of the Invention

The present invention relates to a photocurable resin composition. Further, the present invention also relates to a cured film formed from the photocurable resin composition, and a molded article with the cured film.

### Background Art

In general, polycarbonate resins are widely used as engineering plastics because of their excellent transparency, formability and impact resistance. For example, polycarbonate resins are often used for head lamp lenses, side cover lamp lenses and the like for vehicles. However, polycarbonate resins are used with cured films as protective films provided on their surfaces, since the resins have poor scratch resistance and weather resistance. Such a cured film is formed by coating a coating agent on the resin surface, and curing the coating agent. The thus formed cured film is required to have a good smoothness that does not impair the appearance, weather resistance that prevents the occurrence of discoloration and the like even if exposed to an outdoor environment for long period of time, crack resistance, scratch resistance that makes scratches less easily to occur and abrasion resistance.

As light sources for head lamps have shifted from halogen bulbs to H.I.D bulbs, in recent years, a phenomenon in which a cured film provided on the surface of a head lamp lens turns blue-white and cloudy has been reported. To solve such a technical problem, an active energy ray-curable coating material composition has been proposed which contains a specific monomer and/or an oligomer (A) having one or more radically polymerizable unsaturated double bonds within one molecule (see Patent Document 1, for example).

Further, in order to improve properties such as outdoor durability, UV stability, thermal stability and flexibility, a UV curable coating composition has been proposed which contains specific first and second urethane acrylate resins, and specific bifunctional and trifunctional acrylate monomers (Patent Document 2).

### Citation List

### Patent Documents

Patent Document 1: JP 2003-238845 A
Patent Document 2: JP 6413130 B

### SUMMARY OF THE INVENTION

### Technical Problem

From now on, light sources for head lamps tend to increasingly shift from H.I.D bulbs to LEDs. The present inventors have found out, when an LED is used as a light source for a conventional head lamp lens having a cured film on the surface thereof, that a phenomenon in which the cured film turns white and cloudy upon LED irradiation occurs. Therefore, a cured film is needed that has an excellent transparency upon LED irradiation, as well as excellent performances such as smoothness, adhesion, abrasion resistance, scratch resistance, crack resistance and weather resistance, which are require for a head lamp lens.

Accordingly, an object of the present invention is to provide a photocurable resin composition capable of forming a cured film having an excellent smoothness, adhesion, transparency, abrasion resistance, scratch resistance, crack resistance and weather resistance.

### Solution to Problem

As a result of intensive studies to solve the above-mentioned problem, the present inventors have found out that, in a photocurable resin composition including a urethane (meth)acrylate (A), a (meth)acrylate monomer (B) including a bifunctional (meth)acrylate monomer (b1) and a hexafunctional (meth)acrylate monomer (b2), a photopolymerization initiator (C) and a leveling agent (D), it is possible to solve the above-mentioned problem by controlling the contents of the urethane (meth)acrylate (A), the (meth)acrylate monomer (B) and the bifunctional (meth)acrylate monomer (b1). The present invention has been completed based on such a finding.

Specifically, the present invention provides the following inventions.

A photocurable resin composition including a urethane (meth)acrylate (A), a (meth)acrylate monomer (B), a photopolymerization initiator (C) and a leveling agent (D);
wherein the (meth)acrylate monomer (B) includes at least a bifunctional (meth)acrylate monomer (b1) and a hexafunctional (meth)acrylate monomer (b2);
wherein the content of the urethane (meth)acrylate (A) is 45% by mass or more and 75% by mass or less with respect to the solid content of the photocurable resin composition;
wherein the content of the (meth)acrylate monomer (B) is 20% by mass or more and 45% by mass or less with respect to the solid content of the photocurable resin composition; and
wherein the content of the bifunctional (meth)acrylate monomer (b1) is 35% by mass or more with respect to the content of the (meth)acrylate monomer (B).

The photocurable resin composition according to [1], wherein the content of the hexafunctional (meth)acrylate monomer (b2) is 5% by mass or more with respect to the content of the (meth)acrylate monomer (B).

The photocurable resin composition according to [1] or [2], wherein the urethane (meth)acrylate (A) includes a urethane (meth)acrylate having an isocyanurate skeleton.

The photocurable resin composition according to any one of [1] to [3], wherein the leveling agent (D) has a weight average molecular weight (Mw) of 30,000 or less.

The photocurable resin composition according to any one of [1] to [4], further including an ultraviolet absorber (E).

The photocurable resin composition according to any one of [1] to [5], further including a photostabilizer (F).

The photocurable resin composition according to any one of [1] to [6], wherein the photocurable resin composition is used as a coating for a lamp lens.

A cured film formed from the photocurable resin composition according to any one of [1] to [7].

A molded article having the cured film according to [8] on at least a part of the surface thereof.

The molded article according to [9], wherein the molded article is a lamp lens of a vehicle.

A method of producing a molded article, the method including:
a coating step of coating the photocurable resin composition according to any one of [1] to [8] on at least one surface of a molded article; and
a curing step of curing the photocurable resin composition by UV light irradiation, after the coating step, to form a cured film.

### Advantageous Effects of Invention

According to the present invention, it is possible to provide a photocurable resin composition capable of forming a cured film having an excellent smoothness, adhesion, transparency, abrasion resistance, scratch resistance, crack resistance and weather resistance. Further, according to the present invention, it is also possible to provide a cured film formed from such a photocurable resin composition, and a molded article with the cured film. A molded article having a cured film formed from the photocurable resin composition according to the present invention on a part of the surface thereof has an excellent transparency, and is less susceptible to clouding even upon LED irradiation.

### DETAILED DESCRIPTION OF THE INVENTION

The present invention will be described below in more detail.

In the present specification, the definition of the term “(meth)acrylate” include acrylate and methacrylate, the definition of the term “(meth)acrylic” include acrylic and methacrylic, and the definition of the term “(meth)acryloyl” include acryloyl and methacryloyl.

The term “solid content” refers to the component which is obtained by removing a volatile component such as an organic solvent from the photocurable resin composition, and which constitutes a cured film when cured.

### Photocurable Resin Composition

The photocurable resin composition according to the present invention includes at least a urethane (meth)acrylate (A), a specific(meth)acrylate monomer (B), a photopolymerization initiator (C), and a leveling agent (D). In the present invention, it is possible to form a cured film having an excellent smoothness, adhesion, transparency, abrasion resistance, scratch resistance, crack resistance and weather resistance, by incorporating the components (A) to (D) to the photocurable resin composition, and by controlling the contents of the urethane (meth)acrylate (A) and the (meth)acrylate monomer (B). The photocurable resin composition according to the present invention may further contain an ultraviolet absorber (E), a photostabilizer (F), inorganic particles (G), a solvent (H) and the like. Since a molded article provided with such a cured film is less susceptible to clouding even upon LED irradiation, the photocurable resin composition can be suitably used as a coating for a lamp lens of a vehicle. The respective components included in the photocurable resin composition will be described below in detail.

### (Urethane (Meth)acrylate (A))

The urethane (meth)acrylate (A) contains, within the molecule, an acryloyl group (CH₂=CHCO-) and/or a methacryloyl group (CH₂=C(CH₃)-CO-) as a functional group(s), and a urethane bond (-NH·COO-). The urethane (meth)acrylate is not particularly limited, and can be obtained, for example, by allowing a polyisocyanate, a hydroxyl group-containing (meth)acrylate, and, if necessary, a polyol other than the hydroxyl group-containing (meth)acrylate, to react with one another. The urethane (meth)acrylate (A) is preferably an oligomer or a polymer, and more preferably an oligomer.

The polyisocyanate described above is obtained by allowing a polyol to react with a diisocyanate. The polyol as a raw material for synthesizing the polyisocyanate is not particularly limited, and may be, for example, a polyester polyol, a polyether polyol, a polycarbonate polyol or the like. These polyols may be used singly, or in combination of two or more kinds thereof.

The polyester polyol can be produced by any method without particular limitation, and it is possible to use one obtained by a known method, such as, for example, a method in which a diol and a dicarboxylic acid or a dicarboxylic acid chloride are subjected to a polycondensation reaction, or a method in which a diol or a dicarboxylic acid are esterified and subjected to a transesterification reaction.

The diol to be used in the synthesis of the polyester polyol is not particularly limited, and examples thereof include ethylene glycol, propylene glycol, 1,4-butanediol, 1,6-hexandiol, diethylene glycol, dipropylene glycol, triethylene glycol, tripropylene glycol, tetraethylene glycol and tetrapropylene glycol.

The dicarboxylic acid to be used in the synthesis of the polyester polyol is not particularly limited, and examples thereof include adipic acid, succinic acid, glutaric acid, pimelic acid, sebacic acid, azelaic acid, dimaleic acid, terephthalic acid, isophthalic acid and phthalic acid.

The polyether polyol is not particularly limited, and examples thereof include polyethylene oxide, polypropylene oxide and ethylene oxide-propylene oxide random copolymers.

The polycarbonate polyol is not particularly limited, and may be, for example, a reaction product obtained by the polycondensation of the following component A and component B. Specifically, the component A is not particularly limited, and may be, for example, a diol such as 1,4-butanediol, 1,6-hexandiol, neopentyl glycol, 1,8-octanediol, 1,9-nonanediol, 1,4-cyclohexanedimethanol, 2-methylpropanediol, dipropylene glycol or diethylene glycol, or alternatively, a reaction product of such a diol with a dicarboxylic acid such as oxalic acid, malonic acid, succinic acid, adipic acid, azelaic acid or hexahydrophthalic acid. Further, the component B is not particularly limited, and may be, for example, an aromatic carbonate or an aliphatic carbonate, such as diphenyl carbonate, bis(chlorophenyl)carbonate, dinaphthyl carbonate, phenyl toluyl carbonate, phenyl chlorophenyl carbonate, 2-tolyl-4-tolyl carbonate, dimethyl carbonate, diethyl carbonate, diethylene carbonate or ethylene carbonate.

The diisocyanate as a raw material for synthesizing the polyisocyanate is not particularly limited, and a linear or cyclic aliphatic diisocyanate or an aromatic diisocyanate can be used. Specific examples include: isocyanate group-containing linear hydrocarbons such as tetramethylene diisocyanate and hexamethylene diisocyanate; isocyanate group-containing branched hydrocarbons such as 2,2,4-trimethyl hexamethylene diisocyanate; isocyanate group-containing cyclic hydrocarbons such as isophorone diisocyanate, hydrogenated diphenylmethane diisocyanate, hydrogenated xylene diisocyanate and hydrogenated toluene diisocyanate; and isocyanate group-containing aromatic hydrocarbons such as p-phenylene diisocyanate, 3,3′-dimethyldiphenyl-4,4′-diisocyanate, 1,3-xylene diisocyanate, dianisidine diisocyanate, tetramethylxylene diisocyanate, 1,5-naphthalene diisocyanate, tolylene diisocyanate and 4,4-diphenylmethane diisocyanate.

As the hydroxyl group-containing (meth)acrylate described above, a (meth)acrylate containing at least one or more, preferably from 1 to 5 hydroxyl groups can be used. It is desirable that such a hydroxyl group-containing (meth)acrylate preferably includes a hydrocarbon moiety having from 2 to 20 carbon atoms. The term “hydrocarbon moiety” as used herein refers to an organic group containing a linear or branched aliphatic hydrocarbon group, an alicyclic hydrocarbon group or an aromatic hydrocarbon group, and the aliphatic hydrocarbon group and the alicyclic hydrocarbon group may be saturated or unsaturated. A part of the above-described hydrocarbon moiety may contain an ether bond (C-O-C bond).

Examples of the hydroxyl group-containing (meth)acrylate monomer include: hydroxyalkyl (meth)acrylates such as 2-hydroxyethyl (meth)acrylate and 2-hydroxypropyl (meth)acrylate, and caprolactone adducts thereof (for example, PLACCEL FA1 and FA2, manufactured by Daicel Corporation); OH group-terminated polyalkylene glycol mono(meth)acrylates such as polyethylene glycol mono(meth)acrylate and polypropylene glycol mono(meth)acrylate, and ethylene oxide-modified products thereof (for example, AM-90G and AM-130G manufactured by Shin-Nakamura Chemical Co., Ltd., and LIGHT ACRYLATE EC-A, MTG-A and EHDG-AT manufactured by Kyoeisha Chemical Co., Ltd.); glycerin mono(meth)acrylate (for example, BLEMMER GLM, manufactured by NOF Corporation); glycerin di(meth)acrylate (for example, ARONIX MT3560, manufactured by Toagosei Co., Ltd.), isocyanuric acid EO-modified di(meth)acrylate (for example, ARONIX M-313 and 315, manufactured by Toagosei Co., Ltd.); pentaerythritol tri(meth)acrylate (for example, BISCOAT 300 manufactured by Osaka Organic Chemical Industry Ltd., ARONIX M-305, M-306 and MT-3548 manufactured by Toagosei Co., Ltd., LIGHT ACRYLATE PE-3A manufactured by Kyoeisha Chemical Co., Ltd., and NK ester A-TMM-3L manufactured by Shin-Nakamura Chemical Co., Ltd.); and dipentaerythritol penta(meth)acrylate (for example, ARONIX M-400, M-402, M-403 and MT-3549 manufactured by Toagosei Co., Ltd., LIGHT ACRYLATE DPE-6A manufactured by Kyoeisha Chemical Co., Ltd., and NK ester A-DPH manufactured by Shin-Nakamura Chemical Co., Ltd.). Among these, it is preferred to use isocyanuric acid EO-modified diacrylate or pentaerythritol triacrylate, from the viewpoint of improving the weather resistance, the abrasion resistance and the scratch resistance of the resulting cured film. Such hydroxyl group-containing (meth)acrylates can be used singly, or in a combination of two or more kinds thereof.

As the polyol other than the hydroxyl group-containing (meth)acrylates described above, which is used as necessary, a known polyol such as a polyether polyol, a polyester polyol or a polyolefin polyol can be used. Specific examples thereof include polyoxyethylene glycol, polyoxypropylene glycol, polyoxytetramethylene glycol, ethylene oxide adduct of bisphenol A, propylene oxide adduct of bisphenol A, polycaprolactone polyols and alkylene diols. Such polyols can be used singly, or in a combination of two or more kinds thereof.

Among the above-described urethane (meth)acrylate oligomers (A), a polyfunctional urethane (meth)acrylate is preferred, a urethane (meth)acrylate of bifunctional or higher and 12-functional or lower is more preferred, and a urethane (meth)acrylate of trifunctional or higher and decafunctional or lower is still more preferred, from the viewpoint of improving the abrasion resistance and the scratch resistance of the resulting cured film. From the viewpoint of improving the weather resistance, the use of an aliphatic urethane (meth)acrylate or a urethane (meth)acrylate containing an alicyclic skeleton is preferred, and the use of a urethane (meth)acrylate containing an isocyanurate skeleton is more preferred.

The content of the urethane (meth)acrylate oligomer (A) is 45% by mass or more and 75% by mass or less, preferably 50% by mass or more and 72% by mass or less, and more preferably 55% by mass or more and 70% by mass or less with respect to the solid content of the photocurable resin composition, from the viewpoint of improving the crack resistance, the weather resistance and the like of the resulting cured film.

### ((Meth)acrylate Monomer (B))

The (meth)acrylate monomer (B) is a monomer containing at least one or more (meth)acryloyl groups. The (meth)acrylate monomer (B) has a role as a reactive diluent that adjust the viscosity of the photocurable resin composition, and forms a cured film along with the urethane (meth)acrylate oligomer (A) described above, when the photocurable resin composition is subjected to UV light irradiation.

### (Bifunctional (Meth)acrylate Monomer (b1))

The (meth)acrylate monomer (B) includes at least a bifunctional (meth)acrylate monomer (b1). The term “bifunctional (meth)acrylate monomer” refers to a compound containing two (meth)acryloyloxy groups as functional groups within the molecule. Examples of the bifunctional (meth)acrylate monomer include: alkylene glycol di(meth)acrylates such as ethylene glycol di(meth)acrylate, 1,3-butanediol di(meth)acrylate, 1,4-butanediol di(meth)acrylate, 1,6-hexanediol di(meth)acrylate, 1,9-nonanediol di(meth)acrylate, 1,10-decanediol diacrylate and neopentyl glycol di(meth)acrylate; polyoxyalkylene glycol di(meth)acrylates such as diethylene glycol di(meth)acrylate, triethylene glycol di(meth)acrylate, dipropylene glycol di(meth)acrylate, tripropylene glycol di(meth)acrylate, polyethylene glycol di(meth)acrylate, polypropylene glycol di(meth)acrylate and polytetramethylene glycol di(meth)acrylate; di(meth)acrylates of halogen-substituted alkylene glycols, such as tetrafluoroethylene glycol di(meth)acrylate; di(meth)acrylates of aliphatic polyols, such as trimethylolpropane di(meth)acrylate, ditrimethylolpropane di(meth)acrylate and pentaerythritol di(meth)acrylate; di(meth)acrylates of hydrogenated dicyclopentadiene and tricyclodecane dialkanols, such as hydrogenated dicyclopentadienyl di(meth)acrylate and tricyclodecanedimethanol di(meth)acrylate; di(meth)acrylates of dioxane glycol and dioxane dialkanols, such as 1,3-dioxane-2,5-diyl di(meth)acrylate [another name: dioxane glycol di(meth)acrylate]; di(meth)acrylates of alkylene oxide adducts of bisphenol A and bisphenol F, such as bisphenol A-ethylene oxide adduct diacrylate and bisphenol F-ethylene oxide adduct diacrylate; epoxy di(meth)acrylates of bisphenol A and bisphenol F, such as acrylic acid adduct of bisphenol A diglycidyl ether and acrylic acid adduct of bisphenol F diglycidyl ether; silicone di(meth)acrylate; di(meth)acrylate of hydroxypivalic acid neopentyl glycol ester; 2,2-bis[4-(meth)acryloyloxyethoxyethoxyphenyl]propane; 2,2-bis[4-(meth)acryloyloxyethoxyethoxycyclohexyl]propane; di(meth)acrylate of 2-(2-hydroxy-1,1-dimethylethyl)-5-ethyl-5-hydroxymethyl-1,3-dioxane]; and tris(hydroxyethyl)isocyanurate di(meth)acrylate. Among these bifunctional (meth)acrylate monomers, alkylene glycol di(meth)acrylates, polyoxyalkylene glycol di(meth)acrylates, di(meth)acrylates of halogen-substituted alkylene glycols, di(meth)acrylates of aliphatic polyols, di(meth)acrylates of hydrogenated dicyclopentadiene and tricyclodecane dialkanols, di(meth)acrylates of dioxane glycol and dioxane dialkanols, silicone di(meth)acrylate, di(meth)acrylate of hydroxypivalic acid neopentyl glycol ester, 2,2-bis[4-(meth)acryloyloxyethoxyethoxyphenyl]propane, 2,2-bis[4-(meth)acryloyloxyethoxyethoxycyclohexyl]propane, di(meth)acrylate of 2-(2-hydroxy-1,1-dimethylethyl)-5-ethyl-5-hydroxymethyl-1,3-dioxane] and tris(hydroxyethyl)isocyanurate di(meth)acrylate are preferred, alkylene glycol di(meth)acrylates are more preferred, and 1,6-hexanediol di(meth)acrylate and 1,9-nonanediol di(meth)acrylate are particularly preferred. These monomers may be used singly, or in combination of two or more kinds thereof.

### (Hexafunctional (Meth)acrylate Monomer (b2))

The (meth)acrylate monomer (B) further includes a hexafunctional (meth)acrylate monomer (b2). The term “hexafunctional (meth)acrylate monomer” refers to a compound containing six (meth)acryloyloxy groups as functional groups within the molecule. Examples of the hexafunctional (meth)acrylate monomer include dipentaerythritol hexa(meth)acrylate, alkoxylated dipentaerythritol hexa(meth)acrylates, caprolactone-modified dipentaerythritol hexa(meth)acrylate and polycaprolactone-modified dipentaerythritol hexa(meth)acrylate. These monomers may be used singly, or in combination of two or more kinds thereof. The hexafunctional (meth)acrylate monomer (b2) is preferably a caprolactone-modified product, and more preferably caprolactone-modified dipentaerythritol hexa(meth)acrylate.

### (Other Polyfunctional (Meth)acrylate Monomer (b3))

The (meth)acrylate monomer (B) may further include another polyfunctional (meth)acrylate monomer (b3) other than the bifunctional (meth)acrylate monomer (b1) and the hexafunctional (meth)acrylate monomer (b2) described above. It is preferred to use, for example, a (meth)acrylate monomer of trifunctional or higher and pentafunctional or lower, as the other polyfunctional (meth)acrylate monomer (b3). Examples of the (meth)acrylate monomer of trifunctional or higher and pentafunctional or lower include glycerin tri(meth)acrylate, trimethylolpropane tri(meth)acrylate, ditrimethylolpropane tri(meth)acrylate, ditrimethylolpropane tetra(meth)acrylate, pentaerythritol tri(meth)acrylate, pentaerythritol tetra(meth)acrylate, dipentaerythritol tetra(meth)acrylate and dipentaerythritol penta(meth)acrylate. These monomers may be used singly, or in combination of two or more kinds thereof.

The content of the (meth)acrylate monomer (B) is 20% by mass or more and 45% by mass or less, preferably 21% by mass or more and 42% by mass or less, and more preferably 22% by mass or more and 40% by mass or less with respect to the solid content of the photocurable resin composition, from the viewpoint of improving the scratch resistance, the adhesion and the weather resistance of the resulting cured film. Further, the content of the bifunctional (meth)acrylate monomer (b1) in the (meth)acrylate monomer (B) is 35% by mass or more, and more preferably 40% by mass or more and 95% by mass or less, from the viewpoint of improving the adhesion and the weather resistance of the cured film. The content of the hexafunctional (meth)acrylate monomer (b2) in the (meth)acrylate monomer (B) is preferably 5% by mass or more and 65% by mass or less, and more preferably 10% by mass or more and 60% by mass or less, from the viewpoint of improving the scratch resistance of the cured film.

### (Photopolymerization Initiator (C))

The photopolymerization initiator (C) is not particularly limited, and it is possible to use a conventionally known photopolymerization initiator for UV light curing. The photopolymerization initiator may be, for example, an acylphosphine oxide-based polymerization initiator, an acetophenone-based polymerization initiator, a benzoyl formate-based polymerization initiator, a thioxanthone-based polymerization initiator, an oxime ester-based polymerization initiator, a hydroxybenzoyl-based polymerization initiator, a benzophenone-based polymerization initiator or an α-aminoalkylphenone-based polymerization initiator.

Examples of the acylphosphine oxide-based polymerization initiator include bis(2,4,6-trimethylbenzoyl)-phenylphosphine oxide, 2,4,6-trimethylbenzoyl diphenylphosphine oxide, 2,4,6-trimethylbenzoyl phenylethoxyphosphine oxide, and bis(2,6-dimethoxybenzoyl)-2,4,4-trimethylpentyl phosphine oxide.

Examples of the acetophenone-based polymerization initiator include acetophenone, 3-methylacetophenone, benzyl dimethyl ketal, 2,2-dimethoxy-1,2-diphenylethan-1-one,
1-hydroxy-cyclohexyl-phenyl-ketone,
2-hydroxy-2-methyl-1-phenyl-propan-1-one,
1-[4-(2-hydroxyethoxy)-phenyl]-2-hydroxy-2-methyl-1-propan-1-one and
2-hydroxy-1-{4-[4-(2-hydroxy-2-methyl-propionyl)-benzyl]phenyl}-2-m ethyl-propan-1-one.

Examples of the benzoyl formate-based polymerization initiator include methyl benzoyl formate.

Examples of the thioxanthone-based polymerization initiator include isopropylthioxanthone.

Examples of the oxime ester-based polymerization initiator include 1,2-octanedione,1-[4-(phenylthio)-,2-(O-benzoyloxime)] and ethanone,1-[9-ethyl-6-(2-methylbenzoyl)-9H-carbazol-3-yl]-,1-(O-acetyl oxime).

Examples of the hydroxybenzoyl-based polymerization initiator include 2-hydroxy-2-methyl-1-phenylpropan-1-one, 1-hydroxycyclohexyl phenyl ketone and benzoin alkyl ethers.

Examples of the benzophenone-based polymerization initiator include benzophenone, 4-chlorobenzophenone and 4,4′-diaminobenzophenone.

Examples of the α-aminoalkylphenone-based polymerization initiator include
2-methyl-1-(4-methylthiophenyl)-2-morpholinopropan-1-one and
2-benzyl-2-dimethylamino-1-(4-morpholinophenyl)-butanone-1.

These polymerization initiators may be used singly, or in combination of two or more kinds thereof.

The content of the photopolymerization initiator (C) is preferably 0.1% by mass or more and 10% by mass or less, more preferably 0.5% by mass or more and 7.0% by mass or less, and still more preferably 1.0% by mass or more and 5.0% by mass or less with respect to the solid content of the photocurable resin composition, from the viewpoint of improving the curability and the transparency of the resulting cured film.

### (Leveling Agent (D))

The leveling agent (D) is an agent having the function of adjusting the flowability of the photocurable resin composition, to flatten the coated film. The leveling agent may be, for example, a fluorine-based leveling agent, a silicone-based leveling agent or an acrylic polymer-based leveling agent.

Examples of the fluorine-based leveling agent include fluorine-based leveling agents containing a perfluoroalkenyl group in the main chain or a side chain thereof, such as perfluoroalkenyl carboxylic acid salts, perfluoroalkenyl sulfonic acid salts, perfluoroalkenyl phosphoric acid esters and perfluoroalkenyl betaines; and fluorine-based leveling agents containing a perfluoroalkyl group in the main chain or a side chain thereof, such as perfluoroalkyl polyoxyethylene ethers, perfluoroalkyl carboxylic acid salts, perfluoroalkyl sulfonic acid salts, perfluoroalkyl phosphoric acid esters and perfluoroalkyl betaines.

Examples of the silicone-based leveling agent include polydimethylsiloxane, polymethylphenylsiloxane, polymethylhydrogensiloxane, polyether-modified polydimethylsiloxanes, polyether-modified polymethylphenylsiloxanes and polyether-modified polymethylhydrogensiloxanes.

As the acrylic polymer-based leveling agent, it is possible to use a polyether-modified (meth)acrylic compound represented by the following general formula (1).

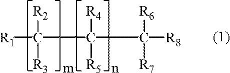

In the general formula (1), R₁ to R₈ may be the same as, or different from one another, at least one of R₁ to R₈ represents a polyether group represented by the following general formula (2), and at least one of R₁ to R₈ represents a (meth)acryloyl group, or a linear or branched C1 to C20 alkyl group containing a (meth)acryloyl group.

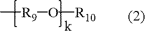

In the general formula (2), R₉ represents a linear or branched C1 to C20 alkylene group; and R₁₀ represents a hydrogen atom, a linear or branched C1 to C20 alkyl group, a linear or branched C2 to C20 alkenyl group or a linear or branched C2 to C20 alkynyl group. Rgs, when present in a plurality of numbers, may be the same as, or different from, one another. k represents an integer of 1 or more. R₁ to R₈ other than those mentioned above each represent a linear or branched C1 to C20 alkyl group. R₂s to R₅s, when present in a plurality of numbers, may be the same as, or different from, one another.

m and n may be the same as, or different from, each other, and each represent an integer of 0 or more, preferably an integer from 1 to 20, and still preferably an integer from 1 to 10.

A commercially available leveling agent can also be used as such a leveling agent. Examples of the fluorine-based leveling agent include Ftergent 602A (trade name) manufactured by NEOS Company Limited. Examples of the silicone-based leveling agent include: BYK-315N, BYK-325N (trade names) and the like, manufactured by BYK Japan KK; POLYFLOW KL-401 (trade name) manufactured by Kyoeisha Chemical Co., Ltd; and Tego flow 425 (trade name) manufactured by EVONIK Industries AG. Examples of the acrylic polymer-based leveling agent include: POLYFLOW No.75 (trade name) manufactured by Kyoeisha Chemical Co., Ltd.; and BYK-350 and BYK-381 (trade names) manufactured by BYK Japan KK. Examples of other leveling agents include BYK-399 (trade name) manufactured by BYK Japan KK.

The leveling agent (D) preferably has a weight average molecular weight (Mw) of from 1,000 to 100,000, more preferably from 2,000 to 50,000, and still more preferably from 3,000 to 30,000, from the viewpoint of improving the smoothness, and the transparency upon LED irradiation, of the resulting cured film. The weight average molecular weight (Mw) can be measured using gel permeation chromatography (GPC).

The content of the leveling agent (D) is preferably 0.01% by mass or more and 5% by mass or less, more preferably 0.05% by mass or more and 2% by mass or less, and still more preferably 0.1% by mass or more and 1% by mass or less with respect to the solid content of the photocurable resin composition, from the viewpoint of improving the smoothness and the weather resistance of the resulting cured film.

### (Ultraviolet Absorber (E))

The ultraviolet absorber (E) is not particularly limited, and a conventionally known ultraviolet absorber can be used. The ultraviolet absorber may be, for example, a benzotriazole-based ultraviolet absorber, a hydroxyphenyl triazine-based ultraviolet absorber or a benzophenone-based ultraviolet absorber. These ultraviolet absorbers may be used singly, or in combination of two or more kinds thereof.

Examples of the benzotriazole-based ultraviolet absorber include
2-[2′-hydroxy-5′-(methacryloyloxymethyl)phenyl]-2H-benzotriazole,
2-[2′-hydroxy-5′-(methacryloyloxyethyl)phenyl]-2H-benzotriazole,
2-[2′-hydroxy-5′-(methacryloyloxypropyl)phenyl]-2H-benzotriazole,
2-[2′-hydroxy-5′-(methacryloyloxyhexyl)phenyl]-2H-benzotriazole,
2-[2′-hydroxy-3′-tert-butyl-5′-(methacryloyloxyethyl)phenyl]-2H-benzotri azole,
2-[2′-hydroxy-5′-tert-butyl-3′-(methacryloyloxyethyl)phenyl]-2H-benzotri azole,
2-[2′-hydroxy-5′-(methacryloyloxyethyl)phenyl]-5-chloro-2H-benzotriazol e,
2-[2′-hydroxy-5′-(methacryloyloxyethyl)phenyl]-5-methoxy-2H-benzotria zole,
2-[2′-hydroxy-5′-(methacryloyloxyethyl)phenyl]-5-cyano-2H-benzotriazol e,
2-[2′-hydroxy-5′-(methacryloyloxyethyl)phenyl]-5-tert-butyl-2H-benzotri azole,
2-[2′-hydroxy-5′-(methacryloyloxyethyl)phenyl]-5-nitro-2H-benzotriazole,
2-(2-hydroxy-5-t-butylphenyl)-2H-benzotriazole, benzenepropanoic acid-3-(2H-benzotriazol-2-yl)-5-(1,1-dimethylethyl)-4-hydroxy-,C7 to C9-branched linear alkyl esters,
2-(2H-benzotriazol-2-yl)-4,6-bis(1-methyl-1-phenylethyl)phenol and
2-(2H-benzotriazol-2-yl)-6-(1-methyl-1-phenylethyl)-4-(1,1,3,3-tetramet hylbutyl)phenol.

Examples of the hydroxyphenyl triazine-based ultraviolet absorber include
2-[4-[(2-hydroxy-3-dodecyloxypropyl)oxy]-2-hydroxyphenyl]4,6-bis(2,4-dimethylphenyl)-1,3,5-triazine,
2-[4-(2-hydroxy-3-tridecyloxypropyl)oxy]-2-hydroxyphenyl]-4,6-bis(2,4-dimethylphenyl)-1,3,5-triazine,
2-[4-[(2-hydroxy-3-(2-ethyl)hexyl)oxy]-2-hydroxyphenyl]-4,6-bis(2,4-di methylphenyl)-1,3,5-triazine,
2,4-bis(2-hydroxy-4-butyloxyphenyl)-6-(2,4-bis-butyloxyphenyl)-1,3,5-tr iazine and
2-(2-hydroxy-4-[1-octyloxycarbonylethoxy]phenyl)-4,6-bis(4-phenylphen yl)-1,3,5-triazine.

Examples of the benzophenone-based ultraviolet absorber include
2,2′,4,4′-tetrahydroxybenzophenone,
2,2′-dihydroxy-4,4′-dimethoxybenzophenone,
2,2′-dihydroxy-4-methoxybenzophenone, 2,4-dihydroxybenzophenone,
2-hydroxy-4-acetoxyethoxybenzophenone,
2-hydroxy-4-methoxybenzophenone, 2,2-dihydroxy -4-methoxybenzophenone, 2,2′-dihydroxy -4,4′-dimethoxybenzophenone,
2-hydroxy-4-n-octoxybenzophenone and
2,2′-dihydroxy-4,4′-dimethoxy-5,5′-disulfobenzophenone-disodium salt.

The content of the ultraviolet absorber (E) is preferably 0.1% by mass or more and 20% by mass or less, more 0.5% by mass or more and 10% by mass or less, and still more preferably 1% by mass or more and 5% by mass or less based on 100% by mass in terms of the solid content of the photocurable resin composition, from the viewpoint of improving the weather resistance of the resulting cured film.

### (Photostabilizer (F))

The photostabilizer (F) is not particularly limited, and a conventionally known photostabilizer can be used. A hindered amine-based light stabilizer is preferably used. Examples of the photostabilizer include bis(2,2,6,6-tetramethyl-4-piperidyl)sebacate, bis(1,2,2,6,6-pentamethyl-4-piperidyl)sebacate,
1-[2-[3-(3,5-t-butyl-4-hydroxyphenyl)propionyloxy]ethyl]-4-[3-(3,5-di-t-butyl-4-hydroxyphenyl)propionyloxy]-2,2,6,6-tetramethylpiperidine,
4-benzoyloxy-2,2,6,6-tetramethylpiperidine,
8-acetyl-3-dodecyl-7,7,9,9-tetramethyl-1,3,8-triazaspiro[4,5]decane-2,4 -dione,
bis-(1,2,2,6,6-pentamethyl-4-piperidyl)-2-(3,5-di-t-butyl-4-hydroxybenz yl)-2-n-butylmalonate,
tetrakis(1,2,2,6,6-pentamethyl-4-piperidyl)-1,2,3,4-butanetetracarboxyla te,
tetrakis(2,2,6,6-tetramethyl-4-piperidyl)-1,2,3,4-butanetetracarboxylate,
(Mixed 1,2,2,6,6-pentamethyl-4-piperidyl/tridecyl)-1,2,3,4-butanetetracarboxyla te, Mixed
{1,2,2,6,6-pentamethyl-4-piperidyl/β,β,β′,β′-tetramethyl-3,9-[2,4,8,10-t etraoxaspiro(5,5)undecane]diethyl}-1,2,3,4-butanetetracarboxylate,
(Mixed1 2,2,6,6-tetramethyl-4-piperidyl/tridecyl)-1,2,3,4-butanetetracarboxylate,
Mixed {2,2,6,6-tetramethyl-4-piperidyl/β,β,β′,β′-tetramethyl-3,9-[2,4,8,10-tetr aoxaspiro(5,5)undecane]diethyl}-1,2,3,4-butanetetracarboxylate, 2,2,6,6-tetramethyl-4-piperidylmethacrylate,
1,2,2,6,6-pentamethyl-4-piperidylmethacrylate,
poly[(6-(1,1,3,3-tetramethylbutyl)imino-1,3,5-triazine-2,4-diyl)][(2,2,6, 6-tetramethyl-4-piperidyl)imino]hexamethylene[(2,2,6,6-tetramethyl-4-p iperidyl)iminol], polymers of dimethyl succinate and
4-hydroxy-2,2,6,6-tetramethyl-1-piperidine ethanol, N,N′,N″,N‴-tetrakis-(4,6-bis-(butyl-(N-methyl-2,2,6,6-tetramethylpiperid in-4-yl)amino)-triazin-2-yl)-4,7-diazadecane-1,10-diamine, polycondensates of dibutyl amine-1,3,5-triazine-N,N′-bis(2,2,6,6-tetramethyl-4-piperidyl-1,6-hexam ethylenediamine and N-(2,2,6,6-tetramethylpiperidyl)butylamine, and decanedioic acid bis(2,2,6,6-tetramethyl-1-(octyloxy)-4-piperidinyl) esters.

The content of the photostabilizer (F) is preferably 0.1% by mass or more and 5% by mass or less, more preferably 0.2% by mass or more and 3% by mass or less, and still more preferably 0.5% by mass or more and 2% by mass or less with respect to the solid content of the photocurable resin composition, from the viewpoint of improving the weather resistance of the resulting cured film.

### (Inorganic Particles (G))

The inorganic particles (G) are not particularly limited, and conventionally known inorganic particles can be used. As the inorganic particles, those dispersed colloidally in a dispersion medium such as water or an organic solvent can be used.

The inorganic particles may be, for example, particles of a metal oxide, such as silica or an oxide of aluminum, titanium, zirconium or zinc, and silica is preferred from the viewpoint of improving the scratch resistance of the resulting cured film. Silica particles in a powder form or a colloidal form can be used as the silica. The silica particles have an average particle size of from 0.001 to 20 µm, preferably from 0.001 µm to 2 µm, more preferably from 0.001 to 0.3 µm, and particularly preferably from 0.005 to 0.08 µm. The shape of the silica particles is not particularly limited. The silica particles may have any of spherical, hollow, porous, rod-like, plate-like, fibrous shapes, but preferably have a spherical shape. The average particle size of the silica particles can be measured by the laser diffraction method.

The silica to be used is more preferably colloidal silica particles. A commercially available product can also be used as the colloidal silica particles. Examples of the commercially available product include IPA-ST, IPA-ST-L, IPA-ST-ZL and PGM-ST (trade names), manufactured by Nissan Chemical Industries, Ltd.

As the inorganic particles, it is possible to use reactive inorganic particles, which are particles of an organic-inorganic hybrid resin obtained by chemically binding inorganic particles with a resin to form a composite.

The resin is not particularly limited, as long as it is capable of chemically binding to inorganic particles to form an organic-inorganic hybrid resin. The resin is preferably one that can be polymerized by photocuring. For example, a urethane (meth)acrylate, a (meth)acrylate or the like is preferred. These resins may be used singly, or in combination of two or more kinds thereof.

The organic-inorganic hybrid resin can be produced by any method without particular limitation, as long as the method can chemically bind inorganic particles with a resin to form a composite. For example, in cases where a resin containing a hydrolyzable silyl group is used as the resin, and silica is used as the inorganic particles, the hydrolyzable silyl group contained in the resin reacts with the silica and a composite can be formed. A preferred embodiment in cases where silica is used as the inorganic particles will be described below.

In a preferred embodiment of the present invention, silica particles containing a reactive (meth)acryloyl group can be used as the reactive inorganic particles. For example, reactive silica particles disclosed in JP H9-100111 A can be used as the reactive silica particles. The reactive silica particles (B) are composed of silica particles and a silane compound chemically bound thereto. The silane compound contains a hydrolyzable silyl group, and a (meth)acryloyl group at the end, and further contains groups represented by the following formulae (a) and (b):

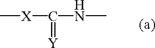

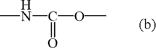

(wherein X is selected from the group consisting of -NH-, —O— and -S-; and Y is selected from the group consisting of an oxygen atom and a sulfur atom, with the proviso that Y is a sulfur atom when X is —O—).

The hydrolyzable silyl group binds to a silanol group present on the surface of the silica particles by hydrolysis and condensation reactions, and the (meth)acryloyl group is used when chemical cross-linking occurs between the molecules after having undergone addition polymerization by active radical species. Each of the group represented by the formula (a) and the group represented by the formula (b) is assumed not only to be a structural unit that binds a molecule containing such a hydrolyzable silyl group with a molecule containing such a (meth)acryloyl group directly, or through another molecule(s), but also plays the role of generating a moderate cohesion between the molecules by hydrogen bonding, and allowing the resulting curable composition to exhibit performances such as excellent mechanical strength, adhesion to a substrate and heat resistance.

Such a silane compound can be synthesized, as disclosed in JP H9-100111 A, for example, by: a method in which a polyalkylene glycol is added to an adduct of a mercaptoalkoxysilane with a polyisocyanate compound, which adduct has an active isocyanate group at the end, to form an alkoxysilane whose one end is hydroxy terminated, and the resulting alkoxysilane is allowed to react with a separately synthesized adduct of a compound having a hydroxyl group at one end and having a (meth)acryloyl group at the other end with a polyisocyanate compound, thereby linking both with a urethane bond; or a method in which an adduct of a mercaptoalkoxysilane with a polyisocyanate compound, which adduct has an active isocyanate group at the end, is allowed to react with a separately synthesized adduct of a polyalkylene glycol polyisocyanate compound having an active hydroxyl group at the end with a compound having a hydroxyl group at one end and having a (meth)acryloyl group at the other end, thereby linking both with a urethane bond.

The reactive silica particles can be prepared using such a silane compound and silica particles. Specifically, the reactive silica particles can be prepared, for example, by:
(1) a method in which a silane compound containing a reactive (meth)acryloyl group is hydrolyzed, and then the resultant and silica particles are mixed, followed by heating and stirring operations; or
(2) a method in which a silane compound containing a reactive (meth)acryloyl group is hydrolyzed in the presence of silica particles.

A commercially available product can also be used as the reactive silica particles. Examples of the commercially available product include PGM-AC-2140Y and PGM-AC-4130Y (trade names) manufactured by Nissan Chemical Industries, Ltd.

The content of the inorganic particles (G) is preferably 0.1% by mass or more and 10% by mass or less, more preferably 0.2% by mass or more and 7% by mass or less, and still more preferably 0.5% by mass or more and 5% by mass or less with respect to the solid content of the photocurable resin composition, from the viewpoint of improving the scratch resistance and the abrasion resistance of the resulting cured film.

### (Solvent (H))

The photocurable resin composition can be diluted with a solvent as necessary, in order to adjust the viscosity to that suitable as a coating. The solvent (H) is not particularly limited, as long as the resin component in the photocurable resin composition can be dissolved in the solvent. Specific examples of the solvent include: aromatic hydrocarbons (such as toluene, xylene and ethylbenzene), esters and ether esters (such as ethyl acetate, butyl acetate and methoxybutyl acetate), ethers (such as diethyl ether, tetrahydrofuran, ethylene glycol monoethyl ether, ethylene glycol monobutyl ether, propylene glycol monomethyl ether and diethylene glycol monoethyl ether), ketones (such as acetone, methyl ethyl ketone, methyl isobutyl ketone, di-n-butyl ketone and cyclohexanone), alcohols (such as methanol, ethanol, n- and i-propanols, n-, i-, sec- and t-butanols, 2-ethylhexyl alcohol and benzyl alcohol), amides (such as dimethylformamide, dimethylacetamide and N-methylpyrrolidone), sulfoxides (such as dimethyl sulfoxide), water, and mixed solvents of two or more kinds of these solvents.

### (Other Components)

The photocurable resin composition according to the present invention may contain any other components other than the above-described components (A) to (H), to the extent that the object of the present invention is not impaired. The photocurable resin composition can contain, as the other component(s), an antistatic agent, a polymerization inhibitor, a non-reactive diluent, a delustering agent, an antifoaming agent, a dispersant, an anti-settling agent, a dispersant, an antioxidant, a thermal stabilizer, an adhesion improver, a photosensitizer, an antibacterial agent, an antifungal agent, an antiviral agent, a silane coupling agent, a plasticizer and/or the like, as necessary.

### Method of Preparing Photocurable Resin Composition

The photocurable resin composition according to the present invention is obtained by mixing and stirring the respective components described above, using an apparatus such as a conventionally known mixer, disperser or stirrer. Such an apparatus may be, for example, a mixing/dispersion mill, a Homodisper a mortar mixer, a roll, a paint shaker, a homogenizer or the like.

The photocurable resin composition (resin solution) preferably has a viscosity at 25° C. of from 0.5 to 500 mPa·s, more preferably from 1 to 250 mPa·s, and still more preferably from 5 to 100 mPa·s. The viscosity can be measured using a Type B viscometer. When the photocurable resin composition has a viscosity within the numerical range described above, the composition can be easily used as a coating, and has an excellent processability.

### Cured Film

The cured film according to the present invention is formed from the above-described photocurable resin composition. The cured film preferably has, but not particularly limited to, a film thickness of from 1 to 100 µm, more preferably from 5 to 50 µm, and still more preferably from 10 to 30 µm, from the viewpoint of maintaining the weather resistance, the scratch resistance, the abrasion resistance and the like. The term “film thickness” as used in the present invention refers to the thickness of the cured film, when a cross section of the cured film is observed by a light microscope, a scanning electron microscope (SEM) or the like. In the case of forming a coating film having such a film thickness, a coating film having a desired thickness may be formed by coating once, or a coating film having a desired thickness may be formed by coating multiple times.

When the cured film according to the present invention has a thickness of 13 µm, the cured film preferably has a haze as measured in accordance with JIS K-7136 of less than 1.0%, more preferably 0.5% or less, and still more preferably 0.3% or less. The cured film has an excellent transparency when the film has a haze within the range described above.

### Molded Article With Cured Film

A molded article with the cured film according to the present invention is a molded article having a cured film formed from the above-described photocurable resin composition on at least a part of the surface thereof. The material of the molded article is not particularly limited, and a molded article made of any of various types of resins can be used. For example, a molded article made of a polyester resin, a polycarbonate resin, a polystyrene resin, a polyolefin resin, a polyether sulfone resin, an acrylonitrile-styrene copolymer resin, a polyamide resin, a cellulose resin, a polyarylate resin, a polymethyl methacrylate resin, a polymethacrylimide resin, etc., is used as the molded article. It is preferred to use a molded article composed of a transparent resin, since a cured film formed from the photocurable resin composition according to the present invention has a low haze and thus has a high transparency.

The molded article is not particularly limited, and a molded article made of any of various types of resins can be used. Since the molded article with the cured film according to the present invention is less susceptible to clouding even upon LED irradiation, in particular, the molded article can be used as a part for LED irradiation. The molded article can be used, for example, as a lamp lens, such as a head lamp lens, a tale lamp lens or a side cover lamp lens for a vehicle, or a light cover for a residential use or for the interior of a train.

### Method of Producing Molded Article With Cured Film

The method of producing a molded article with the cured film according to the present invention includes:
a coating step of coating the above-described photocurable resin composition on at least one surface of a molded article; and
a curing step of curing the photocurable resin composition by UV light irradiation, after the coating step, to form a cured film.

The respective steps will be described below in detail.

### (Coating Step)

The coating step is a step of coating the above-described photocurable resin composition on one surface of a molded article by a conventionally known method. It is possible to use a coating apparatus, such as a spray, a bar coater, a gravure coater, a roll coater (natural roll coater, a reverse roll coater or the like), an air knife coater, a spin coater, a blade coater or the like, to perform coating.

In the case of diluting the resin composition with a solvent before use, it is preferred to dry the composition after the coating. The coated composition can be dried, for example, by a method of drying with hot air (using a dryer or the like). The drying is carried out preferably at a drying temperature of from 10 to 200° C. The upper limit of the drying temperature is more preferably 150° C. from the viewpoint of the smoothness and the appearance of the resulting coating film, and the lower limit thereof is more preferably 30° C. from the viewpoint of drying rate.

### (Curing Step)

The curing step a step of curing the coated photocurable resin composition by irradiating UV light on the coated surface of the molded article, to form a cured film. The curing by UV light can be carried out, for example, by a method of irradiating UV light using a high-pressure mercury lamp, a metal halide lamp, a xenon lamp, a chemical lamp, an UV-LED or the like that emits light within the wavelength range of from 200 to 500 nm. The UV light irradiation is preferably carried out at an irradiation dose of from 100 to 10,000 mJ/cm², and more preferably from 500 to 5,000 mJ/cm², from the viewpoint of improving the curability of the photocurable resin composition and the flexibility of the resulting cured product.

### EXAMPLES

The present invention will now be described more specifically with reference to Examples. However, the present invention is in no way limited to the following Examples.

### Synthesis of Urethane (Meth)acrylate (A)

### Urethane Acrylate (A1)

First, hydrogenated diphenylmethane diisocyanate (hydrogenated MDI, isocyanate group content: 31.8%) was prepared as an isocyanate compound (a1). Further, pentaerythritol triacrylate (hydroxyl value: 110 mg/KOH) was prepared as a (meth)acrylate monomer (a2) containing a hydroxyl group and a photopolymerizable unsaturated group.

Subsequently, 32.8 g of the component (a1), 102 g the component (a2), 3.3 g of diethylene glycol, 0.05 g of p-methoxyphenol, 0.17 g of dibutylhydroxytoluene, 0.17 g of dibutyl tin dilaurate and 17.3 g of butyl acetate were introduced into a 200-mL reaction vessel equipped with a stirring device, a thermometer and an air introduction pipe, and the resulting mixture was allowed to react at 80° C. for 5 hours. Thereafter, 17.3 g of propylene glycol monomethyl ether was added thereto to dilute the reaction mixture, to obtain a urethane acrylate oligomer (A1). The thus obtained component (A1) had a number of functional groups of 6, a weight average molecular weight (MW) of 2,400, and a solid content of 80%.

### Urethane Acrylate (A2)

First, hexamethylene diisocyanate (an isocyanurate form, isocyanate group content: 23.1%) was prepared as an isocyanate compound (a1). Further, pentaerythritol triacrylate (hydroxyl value: 116 mg KOH/g) was prepared as a (meth)acrylate monomer (a2) containing a hydroxyl group and a photopolymerizable unsaturated group.

Subsequently, 100 g of the component (a2), 0.01 g of p-methoxyphenol, 0.04 g of dibutylhydroxytoluene and 0.26 g of dibutyl tin dilaurate were introduced into a 200-mL reaction vessel equipped with a stirring device, a thermometer and an air introduction pipe, and the resulting mixture was heated to 80° C. While maintaining the internal temperature of the flask at 80° C., 34.2 g of the component (a1) was added thereto over 1 hour, and then the resulting mixture was allowed to react for 4 hours, to obtain a urethane acrylate oligomer (A2). The thus obtained component (A2) had a number of functional groups of 9 and a weight average molecular weight (MW) of 3,500.

### Urethane Acrylate (A3)

First, hydrogenated diphenylmethane diisocyanate (hydrogenated MDI), which is an alicyclic isocyanate, was prepared as an isocyanate compound (a1). Further, ETERNACOLL UM-90(3/1) (manufactured by Ube Industries, Ltd.) was prepared as a polycarbonate diol compound (a2). In addition, isocyanuric acid EO-modified di-and tri-acrylate (ARONIX M-313, manufactured by Toagosei Co., Ltd.) was prepared as a photoreactive compound (a3).

Subsequently, 192.8 g of the component (a2), 480.8 g of the component (a3), 0.15 g of 4-methoxyphenol, 0.45 g of dibutylhydroxytoluene and 1.5 g of dibutyltin dilaurate were introduced into a four-neck flask equipped with a stirrer, a reflux condenser and a thermometer. After heating the resulting mixture to 80° C. in an oil bath, 112.3 g of the component (a1) was added thereto over 1 hour, and then the mixture was allowed to react at 90° C. for 3 hours. After the completion of the reaction, 450 g of PGM was added to the reaction mixture, to obtain a urethane acrylate oligomer (A3). The end point of the reaction was confirmed by the disappearance of the peak attributed to the isocyanate group in infrared absorption analysis. The resulting mixture contained 36.3% of PGM, which is an organic solvent, and had a solid content of 63.7%. Further, the thus obtained component (A3) had a number of functional groups of 4 and a weight average molecular weight (MW) of 2,900.

The following materials were used for preparing the photocurable resin composition.

### (Component (A))

Urethane (meth)acrylate oligomer 1: a hexafunctional urethane acrylate, the oligomer (A1) synthesized as described above
Urethane (meth)acrylate oligomer 2: a nonafunctional urethane acrylate having an isocyanurate skeleton, the oligomer (A2) synthesized as described above
Urethane (meth)acrylate oligomer 3: a tetrafunctional urethane acrylate having an isocyanurate skeleton, the oligomer (A3) synthesized as described above

### (Component (b1))

Bifunctional (meth)acrylic monomer 1: 1,10-decanediol diacrylate, trade name: MIRAMER M-2010, manufactured by Miwon Specialty Chemical Co., Ltd.
Bifunctional (meth)acrylic monomer 2: 1,9-nonanediol diacrylate, trade name: LIGHT ACRYLATE 1.9ND-A, manufactured by Kyoeisha Chemical Co., Ltd.
Bifunctional (meth)acrylic monomer 3: 1,6-hexandiol diacrylate, trade name: SR238NS, manufactured by Sartomer Chemicals Ltd.

### (Component (b2))

Hexafunctional (meth)acrylic monomer 1: dipentaerythritol hexa(meth)acrylate (DPHA), trade name: MIRAMER M-600, manufactured by Miwon Specialty Chemical Co., Ltd.
Hexafunctional (meth)acrylic monomer 2: caprolactone-modified DPHA, trade name: EM2692, manufactured by Eternal Chemical Co., Ltd.

### (Component (b3))

Other (meth)acrylic monomer 1: TMPTA (trifunctional), trade name: MIRAMER M-300, manufactured by Miwon Specialty Chemical Co., Ltd.

### (Component (C))

Photopolymerization initiator 1 (an acetophenone-based polymerization initiator, trade name: Omnirad 184, manufactured by IGM Resins B.V.)
Photopolymerization initiator 2 (an acylphosphine oxide-based polymerization initiator, trade name: Omnirad TPO-H, manufactured by IGM Resins B.V.)

### (Component (D))

Leveling agent 1: a non-silicon and non-fluorine-based leveling agent (surface-active polymer), trade name: BYK-399, Mw: 7,000, manufactured by BYK Japan KK
Leveling agent 2: a fluorine-based leveling agent (nonionic fluorine-containing prepolymer, containing an UV reactive group), trade name: Ftergent 602A, Mw: 25,000, manufactured by NEOS Company Limited
Leveling agent 3: a silicone-based leveling agent (polyether-modified polymethylalkylsiloxane), trade name: BYK-325N, Mw: 18,000, manufactured by BYK Japan KK
Leveling agent 4: an acrylic polymer-based leveling agent, trade name: BYK-350, Mw: 22,000, manufactured by BYK Japan KK
Leveling agent 5: a silicone-based leveling agent (polyether siloxane polymer), trade name: Tego flow 425, Mw: 2,100, manufactured by EVONIK Industries AG
Leveling agent 6: a silicone-based leveling agent (polyester-modified polymethylalkylsiloxane), trade name: BYK-315N, Mw: 26,700, manufactured by BYK Japan KK

### (Component (E))

Ultraviolet absorber 1: trade name: TINUVIN 479, manufactured by BASF SE

### (Component (F))

Photostabilizer 1: a hindered amine-based light stabilizer, trade name: TINUVIN 123), manufactured by BASF SE

### (Component (G))

Inorganic particles 1: nano-silica, trade name: PGM-AC2140Y, manufactured by Nissan Chemical Industries, Ltd.

### (Component (H))

Solvent 1: propylene glycol monomethyl ether (PGM)

### Preparation of Photocurable Resin Composition

### Example 1

To 60.3 parts by mass of the solvent (H)-1, 24.0 parts by mass of the urethane (meth)acrylate oligomer (A)-1, 3.2 parts by mass of the urethane (meth)acrylate oligomer (A)-3, 1.0 parts by mass of the hexafunctional (meth)acrylic monomer (b2)-2, 8.5 parts by mass of the bifunctional (meth)acrylic monomer (b1)-2, 1.0 parts by mass of the photopolymerization initiator (C)-1 and 0.2 parts by mass of the photopolymerization initiator (C)-2 as the component (C), 0.1 parts by mass of the leveling agent (D)-2, 1.4 parts by mass of the ultraviolet absorber (E)-1 and 0.3 parts by mass of the photostabilizer (F)-1 were added, and dissolved and stirred to obtain a photocurable resin composition.

### Examples 2 to 15 and Comparative Examples 1 to 6

The same procedure as in Example 1 was repeated, except that the components and the amounts of the components to be incorporated were changed in accordance with the compositions shown in Tables 1 and 2, to obtain photocurable resin compositions.

### Production of Molded Article With Cured Film

On a polycarbonate plate having a thickness of about 2 mm, each of the photocurable resin compositions prepared as described above was coated with a spray to a dry film thickness of about 13 µm, and the coated polycarbonate plate was left to stand in a dryer controlled to 80° C. for 3 minutes. Thereafter, UV light was irradiated (irradiation dose: 3,000 mJ/cm²) using a high-pressure mercury lamp to cure the coating film and to form a cured film, thereby obtaining each molded article with a cured film.

### Evaluation of Substrate With Cured Film

### (Appearance of Coating Film)

The appearance of the cured film of each of the molded articles obtained as described above was observed visually. Specifically, the cured film was observed to check whether or not there are any abnormalities such as bleaching, cissing, insufficient smoothness and cracks, and the appearance was evaluated in accordance with the following criteria. The Evaluation results are shown in Tables 3 and 4.

### (Evaluation Criteria)

Good: no abnormalities such as bleaching, cissing, insufficient smoothness and cracks were observed.

Not acceptable: at least one of abnormalities such as bleaching, cissing, insufficient smoothness and cracks was observed.

### (Initial Adhesion)

In accordance with the cross-cut adhesion test method described in JIS K-5400: 1990, cross-cuts with a width of 1 mm were made using a cutter on the cured film of each of the molded articles obtained as described above, to form 100 squares, thereby preparing a test specimen with cross-cut squares. Subsequently, a piece of Cellotape (registered trademark) (trade name; manufactured by Nichiban Co., Ltd.) was pasted on the test specimen, and then the pasted piece of Cellotape was quickly pulled diagonally upward in a direction 45 degrees with respect to the cross-cut surface to peel off the tape. Then the number of the cross-cut squares of the cured film remaining on each molded article was counted, and the remaining number of the cross-cut squares was used as an index of adhesion. The initial adhesion was evaluated in accordance with the following criteria. The evaluation results are shown in Tables 3 and 4.

### (Evaluation Criteria)

Excellent: the remaining number of the cross-cut squares was 100/100.

Good: the remaining number of the cross-cut squares was 90/100 or more and 99/100 or less.

Acceptable: the remaining number of the cross-cut squares was 80/100 or more and 89/100 or less.

Not acceptable: the remaining number of the cross-cut squares was 79/100 or less.

### (Transparency)

The transparency of the cured film of each of the molded articles obtained as described above was evaluated by the haze (HZ). Specifically, the haze of the cured film was measured using a haze meter (model number: haze meter HM-65W, manufactured by Murakami Color Research Laboratory Co., Ltd.), in accordance with JIS K-7136, and the transparency was evaluated in accordance with the following criteria. The evaluation results are shown in Tables 3 and 4. When the cured film had a haze of less than 1.0%, the cured film was evaluated as having a low turbidity and a high transparency.

### (Evaluation Criteria)

Excellent: the cured film had a haze of less than 0.5%.

Good: the cured film had a haze of 0.5% or more and less than 1.0%.

Acceptable: the cured film had a haze of 1.0% or more and less than 2.0%.

Not acceptable: the cured film had a haze of 2.0% or more.

Further, assuming the case where the head lamp is on, LED (BLUSTER BR-434EG, 480 lumens, manufactured by GENTOS Co., Ltd.) was irradiated from the surface of each of the molded articles obtained as described above on which the cured film had not been formed, the transparency of the portion to which the light had been irradiated was observed visually, and evaluated in accordance with the following criteria. The evaluation results are shown in Tables 3 and 4.

### (Evaluation Criteria)

Excellent: very few bleaching spots were observed.

Good: a few bleaching spots were observed.

Acceptable: some bleaching spots were observed, but there was no practical problem.

Not acceptable: many bleaching spots were observed.

### (Abrasion Resistance)

The abrasion resistance of the cured film of each of the molded articles obtained as described above was evaluated by changes in the haze before and after performing an abrasion resistance test. Specifically, the abrasion resistance test of the cured film was carried out using a Taber abrasion tester (manufactured by Yasuda Seiki Seisakusho Ltd.). Using a wear ring, CS-10F, the difference (ΔHZ) in the haze before and after the abrasion resistance test was measured by rotating 500 times while applying a load of 500 g, and the abrasion resistance was evaluated in accordance with the following criteria. The evaluation results are shown in Tables 3 and 4.

### (Evaluation Criteria)

Excellent: the ΔHZ was less than 5%.

Good: the ΔHZ was 5% or more and less than 15%.

Acceptable: the ΔHZ was 15% or more and less than 20%.

Not acceptable: the ΔHZ was 20% or more.

### (Scratch Resistance)

The scratch resistance of the cured film of each of the molded articles obtained as described above was evaluated by changes in the haze before and after performing a scratch resistance test. Specifically, the scratch resistance test of the cured film was carried out using a plane abrasion tester (PAS-400, manufactured by Daiei Kagaku Seiki Mfg. Co., Ltd.). Using steel wool (#000), the difference (ΔHZ) in the haze before and after the scratch resistance test was measured by reciprocating to-and-fro 50 times while applying a load of 125 g/cm², and the scratch resistance was evaluated in accordance with the following criteria. The evaluation results are shown in Tables 3 and 4.

### (Evaluation Criteria)

Excellent: the ΔHZ was less than 0.5%.

Good: the ΔHZ was 0.5% or more and less than 3%.

Acceptable: the ΔHZ was 3% or more and less than 5%.

Not acceptable: the ΔHZ was 5% or more.

### (Crack Resistance)

The crack resistance of the cured film of each of the molded articles obtained as described above was evaluated by whether the occurrence of cracks was observed or not after performing a crack resistance test. Specifically, the crack resistance test of the cured film was carried out using a thermal shock chamber (model number: TSA-41L-A, manufactured by Espec Corp.). Four cycles, each cycle consisting of leaving to stand for 2 hours under the condition of 130° C., and then leaving to stand for 2 hours at -40° C., were carried out. Thereafter, the cured film was observed visually, and the crack resistance was evaluated in accordance with the following criteria. Those with no cracks were evaluated as having a good crack resistance. Further, the difference (ΔHZ) in the haze before and after the crack resistance test was measured to evaluate and the bleaching (bleed out) of the coating film. The evaluation results are shown in Tables 3 and 4.

### (Evaluation Criteria for Crack Resistance)

Good: the occurrence of cracks was not observed.

Not acceptable: the occurrence of cracks was observed.

### (Evaluation Criteria for Bleaching of Coating Film)

Excellent: the ΔHZ was less than 0.5%.

Good: the ΔHZ was 0.5% or more and less than 3%.

Acceptable: the ΔHZ was 3% or more and less than 5%.

Not acceptable: the ΔHZ was 5% or more.

### (Weather Resistance)

The weather resistance of the cured film of each of the molded articles obtained as described above was evaluated by changes in the appearance, the difference (ΔHZ) in the haze and the difference (ΔYI) in the yellowness index of the cured film before and after performing a weathering test. Specifically, the weathering test of the cured film was carried out using an accelerated weathering tester (model number: SX2D-75, manufactured by Suga Test Instruments Co., Ltd.). The test was carried out at an irradiance of 180 W/m², a black panel temperature of 63° C., and under the pure water-showering condition with a cycle of 18 minutes out of 120 minutes. The weather resistance after 1,000 hours and that after 2,000 hours were evaluated in accordance with the following criteria. The evaluation results are shown in Tables 3 and 4. Since the weathering test after 2,000 hours was not carried out in Comparative Examples 3, 5 and 6, the results thereof are indicated as

### (Evaluation Criteria for Changes in Appearance of Cured Film)

Good: abnormalities such as cracks and peeling were not observed.

Not acceptable: at least one of abnormalities such as cracks and peeling was observed.

### (Evaluation Criteria for Difference in Haze)

Excellent: the ΔHZ was less than 1%.

Good: The ΔHZ was 1% or more and less than 4%.

Acceptable: the ΔHZ was 4% or more and less than 6%.

Not acceptable: the ΔHZ was 6% or more.

### (Evaluation Criteria for Difference in Yellowness Index)

Excellent: the ΔYI was less than 0.5.

Good: the ΔYI was 0.5 or more and less than 1.0.

Acceptable: the ΔYI was 1.0 or more and less than 1.5.

Not acceptable: the ΔYI was 1.5 or more.

TABLE 1

| Component | | Type | Solid content (%) | Example 1 | Example 2 | Example 3 | Example 4 | Example 5 | Example 6 | Example 7 | Example 8 | Example 9 | Example 10 |
|---|---|---|---|---|---|---|---|---|---|---|---|---|---|
| A | | Urethane(meth)acrylate oligomer 1 | 80.0 | 24.00 | 24.00 | 11.50 | 11.50 | 24.00 | 0 | 24.00 | 24.00 | 24.00 | 24.00 |
| | | Urethane(meth)acrylate oligomer 2 | 100.0 | 0 | 0 | 0 | 0 | 0 | 13.00 | 0 | 0 | 0 | 0 |
| | | Urethane(meth)acrylate oligomer 3 | 63.7 | 5.00 | 5.00 | 15.70 | 17.30 | 8.30 | 14.90 | 5.00 | 5.00 | 5.00 | 5.00 |
| B | b2 | Hexafunctional (meth)acrylic monomer 1 | 100.0 | 0 | 0 | 0 | 0 | 0 | 0 | 0 | 0 | 0 | 0 |
| | | Hexafunctional (meth)acrylic monomer 2 | 100.0 | 1.00 | 1.00 | 4.00 | 7.00 | 1.70 | 3.10 | 1.00 | 1.00 | 1.00 | 1.00 |
| | b3 | Trifunctional (meth)acrylic monomer 1 | 100.0 | 0 | 4.00 | 0 | 0 | 0 | 0 | 0 | 0 | 0 | 0 |
| | b1 | Bifunctional (meth)acrylic monomer 1 | 100.0 | 0 | 0 | 0 | 0 | 0 | 0 | 8.50 | 0 | 0 | 0 |
| | | Bifunctional (meth)acrylic monomer 2 | 100.0 | 8.50 | 0 | 9.00 | 5.00 | 0 | 6.50 | 0 | 0 | 8.50 | 8.50 |
| | | Bifunctional (meth)acrylic monomer 3 | 100.0 | 0 | 4.50 | 0 | 0 | 6.00 | 0 | 0 | 8.50 | 0 | 0 |
| c | | Photopolymerization initiator 1 | 100.0 | 1.00 | 1.00 | 1.00 | 1.00 | 1.00 | 1.00 | 1.00 | 1.00 | 1.00 | 1.00 |
| | | Photopolymerization initiator 2 | 100.0 | 0.20 | 0.20 | 0.20 | 0.20 | 0.20 | 0.20 | 0.20 | 0.20 | 0.20 | 0.20 |
| E | | Ultraviolet absorber 1 | 100.0 | 1.40 | 1.40 | 1.40 | 1.40 | 1.40 | 1.40 | 1.40 | 1.40 | 1.40 | 1.40 |
| F | | Photostabilizer 1 | 100.0 | 0.30 | 0.30 | 0.30 | 0.30 | 0.30 | 0.30 | 0.30 | 0.30 | 0.30 | 0.30 |
| D | | Leveling agent 1 | 100.0 | 0 | 0 | 0 | 0 | 0 | 0 | 0 | 0 | 0.10 | 0.05 |
| | | Leveling agent 2 | 50.0 | 0.10 | 0.10 | 0.10 | 0.10 | 0.10 | 0.10 | 0.10 | 0.10 | 0 | 0 |
| | | Leveling agent 3 | 52.0 | 0 | 0 | 0 | 0 | 0 | 0 | 0 | 0 | 0 | 0 |
| | | Leveling agent 4 | 100.0 | 0 | 0 | 0 | 0 | 0 | 0 | 0 | 0 | 0 | 0 |
| | | Leveling agent 5 | 100.0 | 0 | 0 | 0 | 0 | 0 | 0 | 0 | 0 | 0 | 0 |
| | | Leveling agent 6 | 25.0 | 0 | 0 | 0 | 0 | 0 | 0 | 0 | 0 | 0 | 0 |
| G | | Inorganic particles 1 | 47.0 | 0 | 0 | 0 | 0 | 0 | 0 | 0 | 0 | 0 | 0 |
| H | | Solvent 1 | 0.0 | 58.50 | 58.50 | 56.80 | 56.20 | 57.00 | 59.50 | 58.50 | 58.50 | 58.50 | 58.50 |
| Total (parts by mass) | | | | 100.00 | 100.00 | 100.00 | 100.00 | 100.00 | 100.00 | 100.00 | 100.00 | 100.00 | 99.95 |
| Solid content (%) | | | | 34.8 | 34.8 | 35.2 | 35.2 | 35.1 | 35.0 | 34.8 | 34.8 | 34.9 | 34.9 |
| Content (% by mass) of component A with respect to composition (solid content) | | | | 64 | 64 | 55 | 57 | 70 | 57 | 64 | 64 | 64 | 64 |
| Content (% by mass) of component B with respect to composition (solid content) | | | | 27 | 27 | 37 | 34 | 22 | 35 | 27 | 27 | 27 | 27 |
| Content (% by mass) of component b1 in component B | | | | 90 | 47 | 69 | 42 | 78 | 53 | 90 | 90 | 90 | 90 |
| Content (% by mass) of component b2 in component B | | | | 11 | 11 | 31 | 58 | 22 | 32 | 11 | 11 | 11 | 11 |

TABLE 2

| Comp onent | | Type | Solid content (%) | Example 11 | Example 12 | Example 13 | Example 14 | Example 15 | Com. Example 1 | Com. Example 2 | Com. Example 3 | Com. Example 4 | Com. Example 5 | Com. Example 6 |
|---|---|---|---|---|---|---|---|---|---|---|---|---|---|---|
| A | | Urethane (meth)acrylate oligomer 1 | 80.0 | 24.00 | 24.00 | 24.00 | 24.00 | 24.00 | 30.00 | 11.00 | 11.00 | 24.00 | 11.50 | 11.50 |
| | | Urethane (meth)acrylate oligomer 2 | 100.0 | 0 | 0 | 0 | 0 | 0 | 0 | 0 | 0 | 0 | 0 | 0 |
| | | Urethane (meth)acrylate oligomer 3 | 63.7 | 5.00 | 5.00 | 5.00 | 5.00 | 5.00 | 9.40 | 0 | 0 | 5.00 | 15.70 | 15.70 |
| B | b 2 | Hexafunctional (meth)acrylic monomer 1 | 100.0 | 0 | 0 | 0 | 0 | 0 | 0 | 0 | 23.00 | 0 | 0 | 0 |
| | | Hexafunctional (meth)acrylic monomer 2 | 100.0 | 1.00 | 1.00 | 1.00 | 1.00 | 1.00 | 2.00 | 23.00 | 0 | 1.00 | 0 | 0 |
| | b 3 | Trifunctional (meth)acrylic monomer 1 | 100.0 | 0 | 0 | 0 | 0 | 0 | 0 | 0 | 0 | 0 | 0 | 4.00 |
| | b 1 | Bifunctional (meth)acrylic monomer 1 | 100.0 | 0 | 0 | 0 | 0 | 0 | 0 | 0 | 0 | 0 | 0 | 0 |
| | | Bifunctional (meth)acrylic monomer 2 | 100.0 | 8.50 | 8.50 | 8.50 | 8.50 | 8.50 | 0 | 0 | 0 | 8.50 | 9.00 | 9.00 |
| | | Bifunctional (meth)acrylic monomer 3 | 100.0 | 0 | 0 | 0 | 0 | 0 | 0 | 0 | 0 | 0 | 4.00 | 0 |
| C | | Photopolymerization initiator 1 | 100.0 | 1.00 | 1.00 | 1.00 | 1.00 | 1.00 | 1.00 | 1.00 | 1.00 | 1.00 | 1.00 | 1.00 |
| | | Photopolymerization initiator 2 | 100.0 | 0.20 | 0.20 | 0.20 | 0.20 | 0.20 | 0.20 | 0.20 | 0.20 | 0.20 | 0.20 | 0.20 |
| E | | Ultraviolet absorber 1 | 100.0 | 1.40 | 1.40 | 1.40 | 1.40 | 1.40 | 1.40 | 1.40 | 1.40 | 1.40 | 1.40 | 1.40 |
| F | | Photostabilizer 1 | 100.0 | 0.30 | 0.30 | 0.30 | 0.30 | 0.30 | 0.30 | 0.30 | 0.30 | 0.30 | 0.30 | 0.30 |
| D | | Leveling agent 1 | 100.0 | 0 | 0 | 0 | 0 | 0 | 0 | 0 | 0 | 0 | 0 | 0 |
| | | Leveling agent 2 | 50.0 | 0.10 | 0 | 0 | 0 | 0 | 0.10 | 0.10 | 0.10 | 0 | 0.10 | 0.10 |
| | | Leveling agent 3 | 52.0 | 0 | 0.20 | 0 | 0 | 0 | 0 | 0 | 0 | 0 | 0 | 0 |
| | | Leveling agent 4 | 100.0 | 0 | 0 | 0.10 | 0 | 0 | 0 | 0 | 0 | 0 | 0 | 0 |
| | | Leveling agent 5 | 100.0 | 0 | 0 | 0 | 0.10 | 0 | 0 | 0 | 0 | 0 | 0 | 0 |
| | | Leveling agent 6 | 25.0 | 0 | 0 | 0 | 0 | 0.40 | 0 | 0 | 0 | 0 | 0 | 0 |
| G | | Inorganic particles 1 | 47.0 | 1.50 | 0 | 0 | 0 | 0 | 0 | 0 | 0 | 0 | 0 | 0 |
| H | | Solvent 1 | 0.0 | 58.50 | 58.50 | 58.50 | 58.50 | 58.50 | 55.60 | 63.00 | 63.00 | 58.50 | 56.8 | 56.8 |
| Total (parts by mass) | | | | 101.50 | 100.10 | 100.00 | 100.00 | 100.30 | 100.00 | 100.00 | 100.00 | 99.90 | 100.00 | 100.00 |
| Solid content (%) | | | | 35.0 | 34.9 | 34.9 | 34.9 | 34.8 | 34.9 | 34.8 | 34.8 | 34.8 | 35.2 | 35.2 |
| Content (% by mass) of component A with | | | | 63 | 64 | 64 | 64 | 64 | 86 | 25 | 25 | 64 | 55 | 55 |
| respect to composition (solid content) | | | | | | | | | | | | | | |
| Content (% by mass) of component B with respect to composition (solid content) | | | | 27 | 27 | 27 | 27 | 27 | 6 | 66 | 66 | 27 | 37 | 37 |
| Content (% by mass) of component b1 in component B | | | | 90 | 90 | 90 | 90 | 90 | 0 | 0 | 0 | 90 | 100 | 69 |
| Content (% by mass) of component b2 in component B | | | | 11 | 11 | 11 | 11 | 11 | 100 | 100 | 100 | 11 | 0 | 0 |

TABLE 3

| | | | | | | | | | | | | |
|---|---|---|---|---|---|---|---|---|---|---|---|---|
| | | | Example 1 | Example 2 | Example 3 | Example 4 | Example 5 | Example 6 | Example 7 | Example 8 | Example 9 | Example 10 |
| Evaluation items | Appearance of coating film | | Good | Good | Good | Good | Good | Good | Good | Good | Good | Good |
| | Initial adhesion | | Excellent (100/100) | Excellent (100/100) | Excellent (100/100) | Excellent (100/100) | Excellent (100/100) | Excellent (100/100) | Excellent (100/100) | Excellent (100/100) | Excellent (100/100) | Excellent (100/100) |
| | Transparency | HZ | Excellent (0.2) | Excellent (0.2) | Excellent (0.2) | Excellent (0.2) | Excellent (0.2) | Excellent (0.2) | Excellent (0.2) | Excellent (0.1) | Excellent (0.2) | Excellent (0.2) |
| | | Upon LED irradiation | Excellent | Good | Excellent | Good | Good | Excellent | Excellent | Good | Excellent | Excellent |
| | Taber abrasion test ΔHZ (%) | | Good (7.8) | Good (6.5) | Good (9.6) | Excellent (3.8) | Good (7.1) | Good (5.2) | Good (5.3) | Excellent (4.7) | Good (5.0) | Good (7.4) |
| | Scratch resistance ΔHZ (%) | | Good (0.7) | Excellent (0.2) | Good (1.3) | Good (0.8) | Excellent (0.3) | Good (0.7) | Excellent (0.4) | Excellent (0.2) | Good (0.5) | Good (0.6) |
| | Thermal cycle test | ΔHZ (%) | Excellent (0.1) | Excellent (0.0) | Excellent (0.1) | Excellent (0.2) | Excellent (0.1) | Excellent (0.4) | Good (0.5) | Excellent (0.2) | Excellent (0.3) | Good (0.5) |
| | | Presence or absence of cracks | Good | Good | Good | Good | Good | Good | Good | Good | Good | Good |
| | Accelerated weathering test (1,000 h) | Appearance of coating film | Good | Good | Good | Good | Good | Good | Good | Good | Good | Good |
| | | ΔHZ (%) | Excellent (0.4) | Excellent (0.3) | Excellent (0.2 | Excellent (0.3) | Excellent (0.0) | Excellent (0.1) | Excellent (0.3 | Excellent (0.2) | Excellent (0.5) | Excellent (0.4) |
| | | ΔYI | Excellent (0.1) | Excellent (0.1) | Excellent (0.0) | Excellent (0.1) | Excellent (-0.1) | Excellent (0.0) | Excellent (0.2 | Excellent (0.1) | Excellent (0.0) | Excellent (0.0) |
| | Accelerated weathering test (2,000 h) | Appearance of coating film | Good | Good | Good | Good | Good | Good | Good | Good | Good | Good |
| | | ΔHZ (%) | Excellent (0.6) | Good (1.1) | Excellent (0.9) | Excellent (0.8) | Excellent (0.8) | Good (1.0) | Good (1.1) | Excellent (0.6) | Excellent (0.6) | Excellent (0.8) |
| | | ΔYI | Excellent (0.3) | Excellent (0.3) | Excellent (0.3) | Excellent (0.4) | Excellent (0.2) | Excellent (0.3) | Good (0.5) | Excellent (0.4) | Excellent (0.3) | Excellent (0.3) |

TABLE 4

| | | | | | | | | | | | | | |
|---|---|---|---|---|---|---|---|---|---|---|---|---|---|
| | | | Example 11 | Example 12 | Example 13 | Example 14 | Example 15 | Com. Example 1 | Com. Example 2 | Com. Example 3 | Com. Example 4 | Com. Example 5 | Com. Example 6 |
| Evaluation items | Appearance of coating film | | Good | Good | Good | Good | Good | Good | Good | Good | Not acceptable | Good | Good |
| | Initial adhesion | | Excellent (100/100) | Excellent (100/100) | Excellent (100/100) | Excellent (100/100) | Excellent (100/100) | Not acceptable (0/100) | Not acceptable (0/100) | Not acceptable (0/100) | Excellent (100/100) | Excellent (100/100) | Excellent (100/100) |
| | Transparency | HZ (%) | Excellent (0.2) | Excellent (0.1) | Excellent (0.1) | Excellent (0.2) | Excellent (0.1) | Excellent (0.1) | Excellent (0.2) | Good (0.6) | Excellent (0.2) | Excellent (0.3) | Excellent (0.2) |
| | | Upon LED irradiation | Good | Good | Acceptable | Good | Good | Acceptable | Good | Not acceptable | Excellent | Not acceptable | Excellent |
| | Taber abrasion test ΔHZ (%) | | Good (5.0) | Good (7.5) | Good (7.9) | Good (7.1) | Good (7.4) | Good (8.7) | Good (4.9) | Good (4.6) | Good (7.4) | Good (8.3) | Good (6.5) |
| | Scratch resistance ΔHZ (%) ⁿ | | Good (0.5) | Good (0.6) | Good (0.7) | Good (0.6) | Good (0.7) | Excellent (0.4) | Excellent (0.4) | Excellent (0.0) | Excellent (0.3) | Not acceptable (5.2) | Not acceptable (5.2) |
| | Thermal cycle test | ΔΗΖ (%) | Excellent (0.2) | Excellent (0.2) | Excellent (0.1) | Excellent (0.1) | Excellent (0.1.) | Excellent (0.2) | Excellent (0.2) | Good (0.8) | Excellent (0.4) | Excellent (0.0) | Excellent (0.0) |
| | | Presence or absence of cracks | Good | Good | Good | Good | Good | Good | Good | Not acceptable | Good | Good | Good |
| | Accelerated weathering test (1,000 h) | Appearance of coating film | Good | Good | Good | Good | Good | Good | Good | Not acceptable | Not acceptable | Good | Good |
| | | ΔΗΖ (%) | Excellent (0.6) | Excellent (0.3) | Excellent (0.2) | Excellent (0.4) | Excellent (0.3) | Excellent (0.2) | Excellent (0.1) | Not acceptable (7.8) | Excellent (0.3) | Excellent (0.6) | Excellent (0.2) |
| | | ΔYI | Excellent (0.1) | Excellent (0.1) | Excellent (0.1) | Excellent (0.1) | Excellent (0.1) | Excellent (0.4) | Excellent (0.3) | Acceptable (1.0) | Excellent (0.1) | Excellent (-0.1) | Excellent (-0.3) |
| | Accelerated weathering test (2,000 h) | Appearance of coating film | Good | Good | Good | Good | Good | Not acceptable | Not acceptable | - | Not acceptable | - | - |
| | | ΔHZ(%) | Excellent (0.7) | Excellent (0.5) | Excellent (0.6) | Excellent (0.6) | Excellent (0.5) | Excellent (0.6) | Not acceptable (10.7) | - | Excellent (0.7) | - | - |
| | | ΔYI | Excellent (0.4) | Excellent (0.3) | Excellent (0.2) | Excellent (0.2) | Excellent (0.3) | Good (0.6) | Acceptable (1.3) | - | Good (0.6) | - | - |

1. A photocurable resin composition comprising a urethane (meth)acrylate (A), a (meth)acrylate monomer (B), a photopolymerization initiator (C) and a leveling agent (D);
wherein the (meth)acrylate monomer (B) comprises at least a bifunctional (meth)acrylate monomer (b1) and a hexafunctional (meth)acrylate monomer (b2);
wherein the content of the urethane (meth)acrylate (A) is 45% by mass or more and 75% by mass or less with respect to the solid content of the photocurable resin composition;
wherein the content of the (meth)acrylate monomer (B) is 20% by mass or more and 45% by mass or less with respect to the solid content of the photocurable resin composition; and
wherein the content of the bifunctional (meth)acrylate monomer (b1) is 35% by mass or more with respect to the content of the (meth)acrylate monomer (B).

2. The photocurable resin composition according to claim 1, wherein the content of the hexafunctional (meth)acrylate monomer (b2) is 5% by mass or more with respect to the content of the (meth)acrylate monomer (B).

3. The photocurable resin composition according to claim 1, wherein the urethane (meth)acrylate (A) comprises a urethane (meth)acrylate having an isocyanurate skeleton.

4. The photocurable resin composition according to claim 1, wherein the leveling agent (D) has a weight average molecular weight (Mw) of 30,000 or less.

5. The photocurable resin composition according to claim 1, further comprising an ultraviolet absorber (E).

6. The photocurable resin composition according to claim 1, further comprising a photostabilizer (F).

7. The photocurable resin composition according to claim 1, wherein the photocurable resin composition is used as a coating for a lamp lens of a vehicle.

8. A cured film formed from the photocurable resin composition according to claim 1.

9. A molded article having the cured film according to claim 8 on at least a part of the surface thereof.

10. The molded article according to claim 9, wherein the molded article is a lamp lens of a vehicle.

11. A method of producing a molded article, the method comprising:
a coating step of coating the photocurable resin composition according to claim 1 on at least one surface of a molded article; and
a curing step of curing the photocurable resin composition by UV light irradiation, after the coating step, to form a cured film.
